(19) United States
(12) Patent Application Publication
(10) Pub. No.: US 2025/0361152 A1
(43) Pub. Date: Nov. 27, 2025

(54) NEGATIVE ELECTRODE MATERIAL, PREPARATION METHOD THEREFOR AND USE THEREOF IN NICKEL-ZINC BATTERY

(71) Applicant: GP Technology & Innovation Limited, Hong Kong (CN)

(72) Inventors: Bin WANG, Hong Kong (CN); Xian Li, Hong Kong (CN); Yuzhan Zhang, Hong Kong (CN); Xiujuan Jiang, Hong Kong (CN)

(21) Appl. No.: 19/215,698

(22) Filed: May 22, 2025

(30) Foreign Application Priority Data
May 24, 2024 (CN) 202410656373.8

(51) Int. Cl. C01G 9/02; H01M 10/30

(52) U.S. Cl. CPC C01G 9/02; H01M 10/30; C01P 2002/01; C01P 2002/74; C01P 2002/88; C01P 2002/90; C01P 2004/03; C01P 2004/04; C01P 2004/80; C01P 2004/88; C01P 2006/11; C01P 2006/14; C01P 2006/16; C01P 2006/40

(57) ABSTRACT

The present invention relates to a negative electrode material of nickel-zinc battery, having core-shell structure, and comprising zinc oxide core and a carbon coating layer coated on surface of the zinc oxide core. Based on total weight of the negative electrode material, weight fraction of carbon is 2 wt. % to 8 wt. %; tap density of the negative electrode material is 0.90 g/cm³ to 1.40 g/cm³; the carbon coating layer has microporous structure with pore diameter being 1 nm to 4 nm, and a ratio of total volume of micropores with pore diameter in a range of 1 nm to 4 nm in the carbon coating layer to the sum of volume of all micropores of the negative electrode material is 0.1 to 0.5; and thickness of the carbon coating layer is 1 nm to 6 nm. The present invention also relates to a preparation method for the negative electrode material, and use of the negative electrode material in an alkaline nickel-zinc battery. The negative electrode material may significantly improve energy density, cycle life and charge/discharge coulombic efficiency of nickel-zinc battery.

### TECHNICAL FIELD

The present invention relates to the technical field of a material for nickel-zinc battery, particularly relates to a negative electrode material, a preparation method therefor, and use thereof in nickel-zinc battery.

### BACKGROUND

This part provides the relating background information to the present invention, which does not necessarily constitute the prior art.

Alkaline nickel-zinc battery belongs to a typical aqueous battery having characters such as high energy density, high rate performance and intrinsic safety, whose theoretical energy density may be up to 334 Wh/Kg, and possesses discharge capability at a rate of 6 C or more. As the rechargeable aqueous battery, alkaline nickel-zinc battery has higher energy density, rate performance and charge/discharge coulombic efficiency than traditional lead-acid battery and nickel-metal hydride battery; and has privileges such as higher safety and lower cost than lithium-ion battery. It should be pointed out that energy density of nickel-zinc battery may reach or be close to that of lithium iron phosphate battery with organic system. Therefore, nickel-zinc battery is expected to become alternative solutions of traditional lead-acid battery, nickel-metal hydride battery, and lithium-ion battery as power source, and may be widely used in fields such as traction battery and energy storage battery. For example, nickel-zinc battery may be used as mobile power supply for two-wheeled vehicles, three-wheeled vehicles, engineering forklifts, and automatic guided vehicles (AGV) for warehousing etc., and may also be used as uninterruptible power supply (UPS) in industrial data centers, 5G communication base stations, intelligent transportation systems and other fields.

Nickel-zinc battery typically has the positive electrode comprising positive electrode active substance (i.e., nickel hydroxide, nickel oxyhydroxide, or nickel hydroxide coated with cobalt on surface), a negative electrode comprising negative electrode active substance (i.e., zinc, zinc oxide, or zinc hydroxide), a composite separator (i.e., composite separator consisting of a liquid-absorbing non-woven fabric film and dendrite-proof microporous film) for insulating the positive electrode and the negative electrode, and an aqueous alkaline electrolyte solution. With regard to specific structure of positive electrode and negative electrode of nickel-zinc battery, the positive electrode of nickel-zinc battery may usually have a structure wherein pores of metal foam current collector are filled with active substance, and the negative electrode of nickel-zinc battery may usually have a structure wherein surface or void of a current collector with porous planar structure or three dimensional structure is filled with active substance. Wherein, techniques for nickel hydroxide positive electrode of nickel-zinc battery technical are relatively mature, and the nickel hydroxide positive electrode has been successfully applied in systems such as nickel-metal hydride battery, nickel-cadmium battery and nickel-iron battery. Currently, techniques for negative electrode still face rigorous technical challenge, and performance thereof is yet to be further improved and promoted. The composite separator is mainly preparing by materials such as polyethylene or polypropylene, and has better liquid-absorbing capability, alkaline resistance, hydrophilicity and insulating performance. Currently, the composite separator of nickel-zinc battery is mainly composed of a liquid-absorbing non-woven fabric separator of nickel-metal hydride battery and a separator having microporous structure of lithium ion battery. The alkaline electrolyte solution is usually a strong alkaline aqueous solution consisting of sodium hydroxide, potassium hydroxide, lithium hydroxide and the like.

Until now, commercialization progress of techniques for nickel-zinc battery has not been very successful, and the market is mainly dominated by battery products for household consumption, including power supplies for electronic door locks, electric toothbrushes, microphones, electric toys, digital products, and vacuum cleaner. The technical challenge faced by nickel-zinc battery mainly derives from zinc oxide negative electrode side. During charge and discharge reactions of nickel-zinc battery, the zinc oxide negative electrode mainly utilizes dissolution-electrodeposition reaction of metal zinc, a reversible electrochemical reaction is realized, and the coulombic efficiency may be 99% or more. It should be pointed out that, there is also an intermediate phase dissolvable in alkaline electrolyte solution and capable of freely moving, i.e. zincate radical Zn(OH)₄²⁻, between metal zinc in charge state and zinc oxide in discharge state. Since zincate radical in the alkaline electrolyte solution may freely move, density thereof is higher than that of hydroxide ion in the electrolyte solution. When the electrochemical deposition reaction occurs at the negative electrode during charge, zincate radical freely moving easily causes growth of zinc dendrite, resulting in local micro-short circuit and even short circuit of nickel-zinc battery, so that coulombic efficiency and cyclic performance of nickel-zinc battery becomes worse, which cannot meet the needs of practical application scenarios.

Zinc oxide has privileges such as abundant reserves, low cost, and environmental friendliness, may act as an ideal negative electrode material of nickel-zinc battery, and theoretical capacity per gram thereof is up to 658 mAh/g. Since electrical resistivity of zinc oxide is higher, the prepared nickel-zinc battery has the problem of larger internal resistance, directly affecting discharge plateau of battery. Currently, practical discharge plateau of nickel-zinc battery is usually 1.60 to 1.65 V, less than theoretical discharge plateau of 1.73 V. Additionally, active substance such as zinc oxide in negative electrode may also be dissolved in alkaline electrolyte solution, to form zincate radical capable of moving freely. When nickel-zinc battery is subjected to charge/discharge cycles, it is easy to result in deformation of negative electrode, and even to produce zinc dendrite puncturing separator, directly affecting cycle life of nickel-zinc battery.

Additionally, it is easy to occur for side reactions such as chemical corrosion and electrochemical corrosion of zinc negative electrode in charge state in a strong alkaline electrolyte solution, releasing hydrogen gas. At the same time, dense zinc oxide or zinc hydroxide is easily formed on surface of the negative electrode during discharge, hindering occurrence of electrochemical reaction, and causing a problem of surface passivation of the negative electrode. The problem of surface passivation may directly affect utilization rate of the negative electrode active material. In order to further alleviating surface passivation of the zinc negative electrode, nano-meter zinc oxide particles are usually used as the negative electrode active substance. However, since zinc oxide at nano-meter scale usually has particle diameter of 100 to 400 nm, there is obviously a problem of lower tap density (0.72 to 0.77 g/cm³), greatly limiting promotion of energy density of nickel-zinc battery.

Currently, zinc oxide negative electrode material at nano-meter scale may usually exhibit practical capacity per gram of only 200 to 230 mAh/g, and corresponding utilization rate of zinc oxide is only 30% to 35%. Based on nano-meter zinc oxide negative electrode technical, energy density of the prepared nickel-zinc battery is 70 to 90 Wh/Kg, far less than theoretical energy density thereof, 334 Wh/Kg. Discharge voltage plateau of nickel-zinc battery and utilization rate of negative electrode material directly determine energy density and rate performance of a battery system. Therefore, a technique for preparing negative electrode of nickel-zinc battery by using nano-meter zinc oxide as the core material can't meet the needs of energy storage battery and traction battery for high energy density, high rate performance and long cycle life.

For a purpose of solving the above problems at zinc negative electrode side of the existing nickel-zinc battery system, there are currently the following technical solutions.
1. By preparing a porous carbon coating layer on the surface of zinc oxide, zinc oxide composite material with high conductivity, high pore volume and large specific surface area is realized. A core-shell structure of the composite material can effectively alleviate the dissolution and deformation of the zinc negative electrode, but the surface coating of zinc oxide with higher carbon content (carbon content of 10 wt. % or more) and high pore volume tend to reduce tap density of the active material. In addition, the formation of a large amount of graphitic carbon under high temperature conditions also exacerbates the hydrogen evolution side reaction at the negative electrode during charge easily, resulting in decrease of the charge/discharge coulombic efficiency of the battery.
2. A composite material is prepared by loading zinc oxide nanosheets onto graphene by means of in-situ growth via high-temperature hydrothermal reaction. Although the composite material can exhibit better cycling stability, the high-temperature hydrothermal preparation process is relatively complicated and is not suitable for large-scale continuous manufacturing commercially. At the same time, the use of more expensive raw materials is required during the preparation, and there is a problem of sharp increase of manufacturing cost.
3. A composite negative electrode material is prepared by coating a metal oxide layer (e.g., bismuth oxide or tin oxide, etc.) on the surface of zinc oxide. By coating the surface of zinc oxide with the metal oxide layer, the solubility of zinc oxide in an alkaline electrolyte solution can be effectively reduced. Due to strong adhesion of the formed coating layer on the surface, stress problems arising from expansion or contraction of the negative electrode material during cycling may be mitigated. However, the metal oxide has inferior electroconductive performance, which is not conducive to improvement of discharge plateau and capacity per gram of active material. Therefore, the current zinc oxide composite negative electrode material still does not effectively solve the problems of energy density and cycling performance of nickel-zinc batteries.

In order to meet requirement of nickel-zinc battery for application in fields such as traction battery and energy storage battery, energy density, cycle life and rate performance thereof are all to be further strengthened. How to effectively overcome problems due to zinc-based negative electrode in the alkaline electrolyte solution, realize simple and effective preparation of negative electrode material of nickel-zinc battery, and promote overall performance of nickel-zinc battery system, has important practical significance.

### SUMMARY

The present invention aims at overcoming problems of pure zinc oxide negative electrode material at nano-meter scale in alkaline nickel-zinc battery system, such as zinc dendrite generation, surface passivation, deformation of negative electrode sheet, and self corrosion, which leads to failure of the battery to meeting practical application the requirement for energy density, cycle life, rate performance and charge/discharge coulombic efficiency.

The present invention provides a negative electrode material and a preparation method therefor, and use of the negative electrode material in a rechargeable alkaline nickel-zinc battery. By reasonable design of a carbon coating layer, the negative electrode material can significantly alleviate problems such as generation of zinc dendrite, deformation of zinc negative electrode and occurrence of side reaction of hydrogen evolution during charge and discharge, greatly heighten energy density, cycle life, rate performance and coulombic efficiency of the alkaline nickel-zinc battery. Also, it is unexpectedly found that the negative electrode material provided in the present invention has higher tap density (0.90 to 1.40 g/cm³) than that of commercial zinc oxide at nano-meter scale (0.72 to 0.77 g/cm³), and a negative electrode sheet with higher compaction density of nickel-zinc battery may be prepared. Additionally, the negative electrode material provided in the present invention has higher discharge plateau (1.69 to 1.70 V) in nickel-zinc battery system under a condition of 0.2 C, obviously higher than discharge plateau (1.60 to 1.65 V) of commercial pure zinc oxide negative electrode. Therefore, the negative electrode material provided in the present invention contributes to promotion of overall performance of nickel-zinc battery.

In order to realize the above-described objects, the present invention adopts the following technical solution: a negative electrode material having a core-shell structure, comprising zinc oxide core and a carbon coating layer on surface of the zinc oxide core, and further having the following characteristics:
(1) weight fraction of carbon is about 2 wt. % to 8 wt. %, based on total weight of the negative electrode material;
(2) tap density of the negative electrode material is about 0.90 g/cm³ to 1.40 g/cm³;
(3) the carbon coating layer has microporous structure with pore diameter of about 1 nm to 4 nm, and a ratio of total volume of micropores with pore diameter in a range of 1 nm to 4 nm in the carbon coating layer to sum of volumes of all micropores of the negative electrode material is about 0.1 to 0.5;
(4) thickness of the carbon coating layer is about 2 nm to 6 nm; and
(5) a content ratio of graphitic carbon to amorphous carbon in the carbon coating layer is about 0.3 to 0.9:1.

It is unexpectedly found by the inventors that the negative electrode material provided in the present invention significantly reduces solubility of zinc oxide in the alkaline electrolyte solution. Although principle thereof is not yet clear, the inventors speculate that zinc oxide may produce soluble zinc salts (for example, a zinc salt containing zincate radical) in the alkaline electrolyte solution. The carbon coating layer of the negative electrode material provided in the present invention has microporous structure with pore diameter of about 1 nm to 4 nm. Therefore, theoretically, the soluble zincate anions Zn(OH)₄²⁻ with average diameter of about 6 Å are easily aggregated within a micropore with pore diameter of about 1 nm to 4 nm, producing “anion crowding effect”, and effectively limiting random diffusion of Zn(OH)₄²⁻ from the negative electrode sheet to the alkaline electrolyte solution. By effectively limiting random diffusion of zincate radical as the formed intermediate product in electrochemical environment, the soluble zinc salt may be effectively hindered from randomly entering the alkaline electrolyte solution. This effect greatly improves growth of zinc dendrite and deformation of the negative electrode sheet during charge and discharge, being conducive to realizing long cycle life of nickel-zinc battery. At the same time, the carbon coating layer has micropores with pore diameter of about 1 nm to 4 nm, which may meet free shuttle back and forth of hydroxide ions (average diameter: 1.4 Å) between the positive electrode and the negative electrode during charge and discharge, without affecting rate performance of nickel-zinc battery. When the pore diameter of the carbon-coated microporous structure is less than 1 nm or more than 4 nm, the above-described “anion crowding effect” can't be produced.

The carbon coating layer of the negative electrode material provided in the present invention has microporous structure with pore diameter of about 1 nm to 4 nm, and a ratio of total volume of micropores with pore diameter in a range of 1 nm to 4 nm in the carbon coating layer to sum of volumes of all micropores of the negative electrode material is 0.1 to 0.5. It is unexpectedly found by the inventors that, when this ratio is less than 0.1, effect of the negative electrode material reducing solubility of zinc oxide in the alkaline electrolyte solution is significantly weakened; and when this ratio is more than 0.5, adverse effect may be imposed on tap density of the negative electrode material.

The present invention provides use of the above-described negative electrode material in nickel-zinc battery. The negative electrode material is applied in preparing a negative electrode of nickel-zinc battery, whose discharge plateau, energy density, cyclic performance, rate performance and charge/discharge coulombic efficiency are all promoted significantly.

In one or more embodiments, capacity per gram of the negative electrode material is 400 mAh/g or more, and discharge plateau of nickel-zinc battery using the negative electrode material is about 1.69 to 1.70 V.

In one or more embodiments, powder resistivity of the negative electrode material is about 10² to 10⁴ Ω·cm.

In one or more embodiments, the negative electrode material has specific surface area of about 5 to 30 m²/g based on nitrogen adsorption method (multi-point BET).

In one or more embodiments, the negative electrode material is subjected to Raman spectrum test, and it is found that a content ratio of graphitic carbon to amorphous carbon in the carbon coating layer of the negative electrode material is about 0.3 to 0.9:1. An appropriate proportion of graphitic carbon in the carbon coating layer may enhance electrically conductive performance of the negative electrode material to a certain degree. By reducing internal resistance of nickel-zinc battery, discharge plateau may be effectively promoted, and cycle life and rate performance may be improved. However, excessively high proportion of graphitic carbon may reduce hydrogen evolution overpotential of the negative electrode, which will result in aggravation of side reaction of hydrogen evolution at zinc negative electrode, reduce charge/discharge coulombic efficiency of battery, and even lead to leakage of the electrolyte solution from nickel-zinc battery. However, an appropriate amount of amorphous carbon may not only enrich the microporous structure of negative electrode material. Growth of zinc dendrite and deformation of negative electrode are effectively inhibited by “anion crowding effect” during charge, and moreover, side reaction of hydrogen evolution at the zinc negative electrode may be effectively alleviated, promoting charge/discharge coulombic efficiency and cycle life. It is found by the inventors that the content ratio of graphitic carbon to amorphous carbon in the carbon coating layer of the negative electrode material in the above-described range may meet requirements for improvement of discharge plateau, cycle life, rate performance and coulombic efficiency of battery at the same time.

The present invention also provides a method for the above-described negative electrode material preparation, including the following steps:
a step of preparing a first solution by dissolving an organic zinc source in a solvent;
a step of preparing a second solution by putting a vinyl-based polymer emulsion and/or a polyurethane resin in the first solution and uniformly mixing them;
a step of preparing slurry by uniformly dispersing zinc oxide particles in the second solution;
a step of preparing a precursor by subjecting the slurry to spray drying;
a step of preparing the negative electrode material by sequentially subjecting the precursor to heat treatment, pulverization, and sieving.

In one or more embodiments, the organic zinc source comprises at least one of a organic zinc compound represented by general formula (1), a organic zinc compound represented by general formula (2), a organic zinc compound represented by general formula (3) described below, and zinc salt compounds of organic acid.

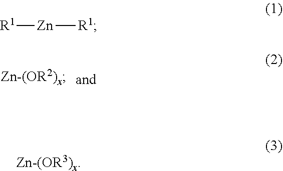

In the general formula (1), R¹ is a straight-chain or branched alkyl with carbon number of 1 to 7, which may be exemplified as methyl, ethyl, propyl, isopropyl, butyl, isobutyl, sec-butyl, tert-butyl, pentyl, isopentyl, neopentyl, tert-pentyl, hexyl, isohexyl, sec-hexyl, tert-hexyl, 2-hexyl and heptyl, preferably methyl, ethyl, propyl, and further preferably, ethyl.

In the general formula (2), R² is a straight-chain or branched alkyl with carbon number of 1 to 8, which may be exemplified as methyl, ethyl, propyl, isopropyl, butyl, isobutyl, sec-butyl, tert-butyl, pentyl, isopentyl, neopentyl, tert-pentyl, hexyl, isohexyl, sec-hexyl, tert-hexyl, 2-hexyl, 2-ethylhexyl and heptyl, preferably ethyl, propyl, isopropyl, 2-ethylhexyl; and X is an integer in a range of 1 to 8.

In the general formula (3), R³ is a straight-chain or branched alkyl with carbon number of 1 to 4, and specific examples of alkyl for R³ are same as specific examples of alkyl for R²; and X is an integer in a range of 1 to 8.

In one or more embodiments, the organic zinc source is zinc acetate compounds, whose thermal decomposition products include ZnO, CH₄, CO₂ and H₂O. As the zinc acetate compounds in the present invention, it is preferable to have a molecule formula of Zn₄(OH)₂(O₂CCH₃)₆·2H₂O. Molecule structure thereof comprises one tetrahedral Zn₄O group, with the central oxygen atom involved in hydrogen bonding. The four zinc atoms are coordinated to oxygen atom from one water molecule, and simultaneously, each of them is bonded to one of the oxygen atoms from three acetate radicals, forming a cage-like compound on a macroscopic scale.

In one or more embodiments, the organic zinc source is zinc salt compound of organic acid. As the preferable zinc salt compounds of organic acid, the following ones may be exemplified: zinc acetate, zinc propionate, zinc butyrate, zinc valerate, zinc caproate, zinc caprylate, zinc stearate, zinc bis(2-ethylcaproate), zinc bis(butyrate), zinc oxalate, zinc gluconate, zinc citrate, zinc lactate and the like. More preferably, the zinc salt compound of organic acid is zinc gluconate.

Wherein, the solvent is deionized water, an organic solvent or mixture thereof. As the organic solvent, an organic solvent having certain solubility to the organic zinc source may be used. For example, an electron-donating organic solvent and a hydrocarbon compound may be exemplified. As the electron-donating organic solvent, for example, the following ones may be exemplified: cyclic amides such as N-methyl-2-pyrrolidone, 1,3-dimethyl-imidazolinone, and 1,3-dimethyl-3,4,5,6-tetrahydro-2(1H)-pyrimidone; ethers such as diethylether, tetrahydrofuran, diisopropylether, din-butylether, dialkyl ethylene glycol, dialkyl diethylene glycol, and dialkyl triethylene glycol; and solvents such as ethylene glycol dimethylether, diethylene glycol dimethylether, and triethylene glycol dimethylether. In addition, as the hydrocarbon compound, the following ones may be exemplified: aliphatic hydrocarbons such as n-hexane, octane, and n-decane; alicyclic hydrocarbons such as cyclopentane, cyclohexane, methylcyclohexane, and ethylcyclohexane; aromatic hydrocarbons such as benzene, toluene, xylene, and cumene; and hydrocarbon solvents such as mineral oil concentrate, solvent naphtha, kerosene, petroleum ether, and the like. The organic solvent may be the electron-donating solvent, the hydrocarbon compound or mixture thereof.

Wherein, a vinyl-based polymer emulsion is obtained by adding a free radical polymerization initiator to one or more of vinyl-based monomers, preparing an emulsified dispersion in an aqueous medium containing a surfactant, and subjecting them to emulsion polymerization (polymerization reaction or copolymerization reaction). In the vinyl-based polymer emulsion, the vinyl-based polymer is dispersed in an aqueous phase in a form of emulsion particles or latex particles. The vinyl-based polymer emulsion in the present invention may be in an emulsion form with uniform emulsified particles of vinyl polymer or vinyl copolymer dispersed in the aqueous phase, and may also be in an emulsion form with latex particles of vinyl copolymer having core-shell structure emulsified and dispersed in the aqueous phase.

As the vinyl-based polymer emulsion in the present invention, an emulsion of acrylic acid-based copolymer formed through copolymerization of acrylate monomer or methylacrylate monomer is preferable. The acrylic acid-based copolymer may comprise alkyls with the number of carbon atom of 6 or more, or styryl, and also be an acrylic acid-based copolymer containing hydrophilic groups such as hydroxy group within the molecule.

As the vinyl-based polymer emulsion in the present invention, it is preferable that an emulsion of acrylic acid-based copolymer may be exemplified, which is one or more selected from a group consisting of alkyl acrylate/methylacrylate copolymer and acrylic acid/methylacrylic acid styrene copolymer.

Wherein, the polyurethane resin includes a plurality of polyurethane resins obtained by reacting a macromolecular polyhydric alcohol, a polyisocyanate and a chain extender, and every polyurethane resin comprises different macromolecular polyhydric alcohols from each other, and forms a chemical bond with each other partially by the chain extender.

As the macromolecular polyhydric alcohol, for example, a hydrophobic macromolecular polyhydric alcohol and a hydrophilic macromolecular polyhydric alcohol may be exemplified.

As the hydrophobic macromolecular polyhydric alcohol, there are no special restrictions, which may be exemplified as, for example, polyester polyhydric alcohol, polycarbonate polyhydric alcohol, polyoxy-polyalkylene polyhydric alcohol with the number of carbon atom of alkylene of 3 to 10 and the like. Polyoxy-polyalkylene polyhydric alcohol with the number of carbon atom of alkylene of 3 to 7 is preferably exemplified, and polyoxy-polyalkylene polyhydric alcohol with the number of carbon atom of alkylene of 4-6 is more preferably exemplified. These hydrophobic macromolecular polyhydric alcohols have a molecular weight (number-average molecular weight) of usually around 300 to 10000, preferably around 500 to 5000.

As the hydrophilic macromolecular polyhydric alcohol, there are no special restrictions, which may be exemplified as, for example, polyalkylene oxide polyhydric alcohol having 50 wt. % or more of polyethylene oxide. This polyalkylene oxide polyhydric alcohol may be exemplified as a block copolymer or random copolymer obtained by addition reaction of alkylene oxide comprising 50 wt. % or more of ethylene oxide, having polyhydric alcohol with low molecular weight as an initiator. Polyethylene glycol is preferably exemplified, and polyethylene glycol with number-average molecular weight of 500 to 3000 is more preferably exemplified.

As the polyisocyanate, there are no special restrictions, as long as it is usually used for manufacturing polyurethane resin, which may be exemplified as, for example, aromatic diisocyanate, aromatic aliphatic diisocyanate, aliphatic diisocyanate, alicyclic diisocyanate and derivatives and modifiers of these diisocyanate. These polyisocyanate may be used alone, and two or more of them may also be used in combination.

As the chain extender, there are no special restrictions, which may be exemplified as, for example, amines such as alkoxysilane-based compound having primary amino group or primary amino group and secondary amino group, and polyamines such as polyamine containing polyethylene oxide group. Preferably, the polyurethane resin adopted in the present invention is waterborne polyurethane resin, which comprises a plurality of the above-described polyurethane resins, for example, two or more polyurethane resins, i.e., the waterborne polyurethane resin comprises a plurality of polyurethane resins containing different macromolecular polyhydric alcohols from each other.

In one or more embodiments, the waterborne polyurethane resin comprises, for example, hydrophobic polyurethane resin obtained by a reaction between hydrophobic macromolecular polyhydric alcohol as a first macromolecular polyhydric alcohol, the above-described polyisocyanate and the above-described chain extender, and hydrophilic polyurethane resin obtained by a reaction between hydrophilic macromolecular polyhydric alcohol as a second macromolecular polyhydric alcohol, the above-described polyisocyanate and the above-described chain extender. Also, each of the above-described polyurethane resins (hydrophobic polyurethane resin and hydrophilic polyurethane resin) partly forms chemical bonds with each other by the chain extender. A part of the chemical bonds are chemical bond produced by a reaction between the above-described chain extender and polyisocyanate of various waterborne polyurethane resins, particularly, urea bond produced by a reaction between amino group of polyamine with isocyanate group of various waterborne polyurethane resins.

Spray drying technique is a technique for preparing precursor particles capable of controlling particle size and shape of the resulting precursor. During spray drying, homogeneous droplets enter spray drying equipment via a peristaltic pump and are rapidly ejected from flywheel or nozzle in a mist form. Through rapid evaporation of solvent, a solid residue is left. The particle size and shape of the resulting precursor is related to the characteristics of the droplets formed during spraying. Structural reorganization of the particles may be affected by changes in volume and size of the droplets, depending on conditions of the spray drying process, such as feed rate of the peristaltic pump, drying temperature, rotation speed of atomizer nozzle and the like factors. By reasonably varying the conditions of the spray drying process, large, small or aggregated particles can be prepared. Particles with homogeneous composition or being a mixture of solution components can be also produced upon these conditions. The zinc oxide particles in the slurry can help to control the shape and composition of the precursor particles during spray drying.

The spray drying may be performed by means of any appropriate prior art. The slurry is atomized into discrete roughly spherical particles with suitable atomization equipment, and design value of evaporation capacity for spray drying is usually 5 L/h-100 L/h. Atomization is carried out by passing the slurry through an atomizer along with an inert dry gas or air. Atomization may be carried out by using atomizing nozzle or centrifugal high-speed discs. Volume flow rate of the dry gas is significantly higher than that of the slurry, so that the atomization of the slurry and the removal of solvent are carried out. The dry gas should not undergo chemical reaction under the conditions used in the atomization process. Suitable gases include air, oxygen, nitrogen, argon and carbon dioxide. However, any other gas may be used, as long as it is non-reactive and completes the desired drying of the precursor. Spray-dried precursor particles are also characterized by their particle size distribution. As used herein, the terms “D₁₀”, “D₅₀”, and “D₉₀” refer to respective percentages of the lognormal particle size distribution determined by a particle size analyzer using a hexane solvent. Typically, the spray-dried precursor particles have D₅₀ values of about 5 μm to 20 μm.

In one or more embodiments, concentration of the organic zinc source in the first solution is 0.01 to 0.2 mol/L.

In one or more embodiments, a ratio of weight of the vinyl-based polymer emulsion and/or polyurethane resin to weight of the first solution is 1:4 to 10.

In one or more embodiments, a weight ratio of the zinc oxide particles to the organic zinc source is 5 to 20:1.

In one or more embodiments, the solvent is deionized water, the organic zinc source is zinc gluconate, and the second solution is prepared by putting a mixture consisting of polyvinyl alcohol, polyurethane and polyacrylic acid in the first solution and uniformly mixing them.

In one or more embodiments, evaporation amount of the spray drying equipment is 5 L/h.

In one or more embodiments, frequency range of the atomizer in the spray drying equipment is 320 to 380.

In one or more embodiments, inlet temperature of the spray drying is 200 to 300° C.;

In one or more embodiments, outlet temperature of the spray drying is 85 to 100° C.

In one or more embodiments, steps of subjecting the precursor to heat treatment include: under a protective gas atmosphere (such as N₂, Ar, He, or CO₂), placing the precursor in a box furnace, heating it up to 500 to 800° C. at a heating rate of 1 to 15° C./min, and reacting it for 1 to 10 hours.

In one or more embodiments, steps of subjecting the precursor to heat treatment include: under a protective gas atmosphere (such as N₂, Ar, He, or CO₂), placing the precursor in a rotary tube furnace, heating it up to 600 to 900° C. at a heating rate of 1 to 15° C./min, and reacting it for 1 to 5 hours.

Further treatments of pulverizing and sieving are required for a sample subjected to heat treatment, so that a composite negative electrode material of carbon-coated zinc oxide with high tap density, reasonable particle diameter distribution, and low powder resistivity may be prepared.

In one or more embodiments, an ultrasonic sieving step is required for the sample subjected to heat treatment, and an ultrasonic sieving mesh has a mesh number of 300 to 500.

In one or more embodiments, a negative electrode material prepared by adopting the preparation method provided in the present invention has such physical parameters that:
(1) tap density thereof is about 0.90 to 1.40 g/cm³;
(2) particle diameter distribution D₅₀ thereof is 1 to 10 μm;
(3) powder resistivity thereof is about 10² to 10⁴ Ω·cm;
(4) content of the carbon coating layer is 2 wt. %-8 wt. %;
(5) thickness of the carbon coating layer is about 1 to 6 nm; and
(6) the carbon coating layer has microporous structure with pore diameter of about 1 nm to 4 nm, and a ratio of total volume of micropores with pore diameter in a range of 1 nm to 4 nm in the carbon coating layer to sum of volumes of all micropores of the negative electrode material is 0.1 to 0.5.

In comparison with the prior art, the present invention has the following beneficial effects.
(1) The present invention provides a preparation method for negative electrode material, directly using organic zinc source and zinc oxide as raw materials, and the negative electrode material may exhibit excellent electrochemical activity and reversibility when applied in alkaline nickel-zinc battery. The negative electrode material is conducive to promoting performance of capacity per gram of zinc oxide (capacity per gram of 400 mAh/g or more, and utilization rate of the active material ZnO of 60% or more), cycle life and charge/discharge coulombic efficiency of nickel-zinc battery.
(2) The present invention provides a preparation method for negative electrode material, which realize preparation with controllable carbon content and proportion of carbon components of the carbon coating layer, and may enable large-scale production, by ingenious design of double carbon sources. The preparation method has advantages such as simplicity, shorter period, high repeatability, wide applicable range, without need of treatment with strong acid and strong alkali, and without need of subsequent wastewater discharge treatment, and is suitable for large-scale production and marketization promotion.
(3) The negative electrode material provided in the present invention has higher electroconductivity, which is 2˜4 orders of magnitude higher than that of nano zinc oxide. Internal resistance of the battery may be greatly reduced when the negative electrode material is applied in alkaline nickel-zinc battery, achieving objects of improving discharge plateau and rate performance. More particularly, in comparison with a nickel-zinc battery prepared by using nano-meter zinc oxide negative electrode material, a nickel-zinc battery manufactured by using the negative electrode material provided in the present invention may have high discharge plateau of 40 to 100 mV, and energy density of 120 Wh/Kg or more. Therefore, the nickel-zinc battery manufactured by using the negative electrode material provided in the present invention has higher energy density and rate performance.
(4) The negative electrode material provided in the present invention has reasonable carbon coating layer and pore diameter distribution. By reasonable design of the carbon coating layer, “anion crowding effect” may be manufactured so as to inhibit random diffusion of zincate radical into alkaline electrolyte solution. Moreover, reasonable design of the microporous structure is also conducive to quick permeation and diffusion of the alkaline electrolyte solution to negative electrode sheet, without sacrificing tap density. Additionally, the negative electrode material provided in the present invention has higher tap density (0.90 to 1.40 g/cm³), obviously higher than that of nano-meter zinc oxide material (0.72 to 0.77 g/cm³), which may conform development direction toward a technique route of nickel-zinc battery with high energy density.

The present invention is further described below in combination with specific Examples.

### BRIEF DESCRIPTION OF 7L S

The present invention is further described in conjunction with drawings. However, Examples in drawings does not constitute any limitation on the present invention.

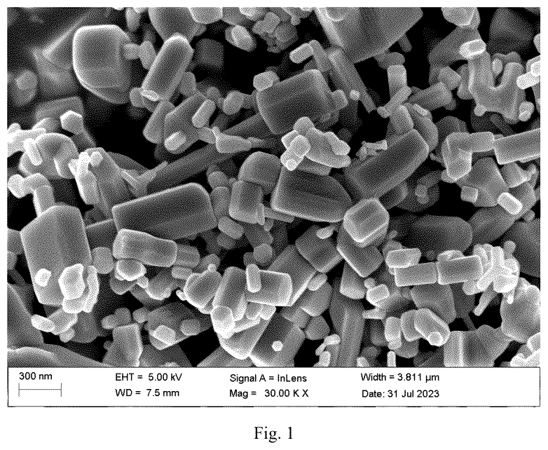

FIG. 1 shows a field emission scanning electron microscope image of nano-meter zinc oxide particles adopted in preparing a negative electrode material in Example 1 of the present invention.

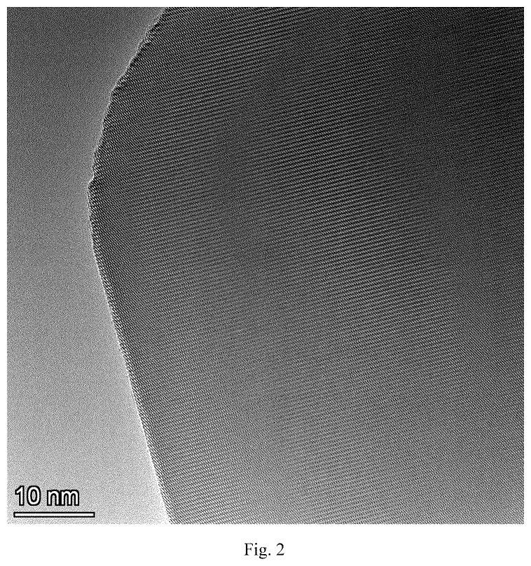

FIG. 2 shows an image of microscopic structure of nano-meter zinc oxide particles adopted in preparing the negative electrode material in Example 1 of the present invention, characterized with high resolution transmission electron microscope.

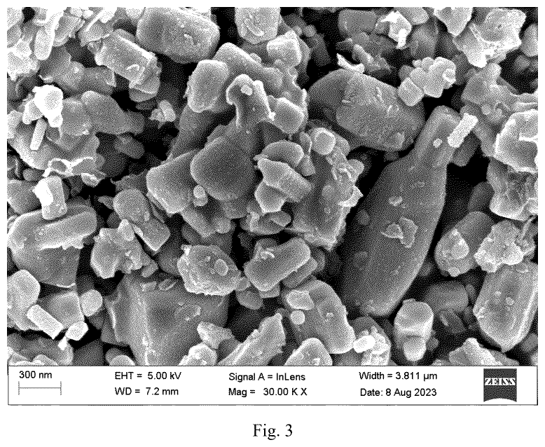

FIG. 3 shows a field emission scanning electron microscope image of the negative electrode material prepared in Example 1 of the present invention.

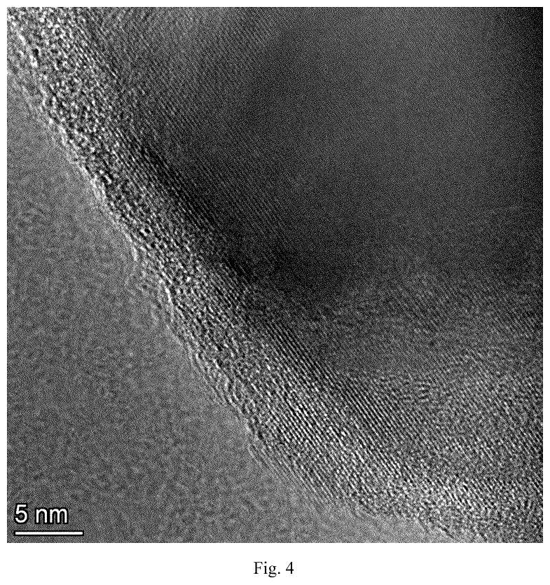

FIG. 4 shows an image of microscopic structure of the negative electrode material prepared in Example 1 of the present invention, characterized with high resolution transmission electron microscope.

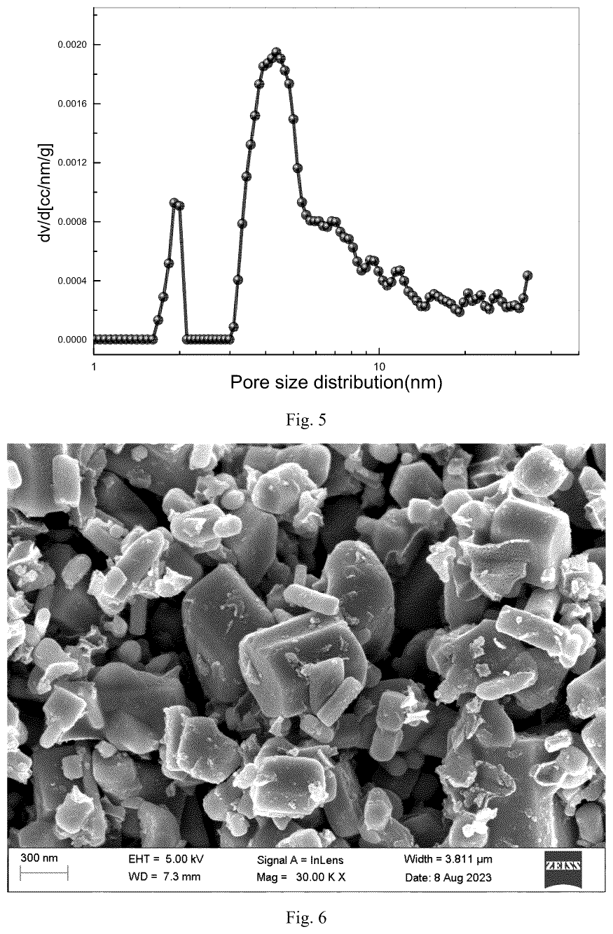

FIG. 5 shows a diagram of pore diameter distribution measurement result of the negative electrode material prepared in Example 1 of the present invention, obtained via non-localized density functional theory (NLDFT).

FIG. 6 shows a field emission scanning electron microscope image of a negative electrode material prepared in Example 2 of the present invention.

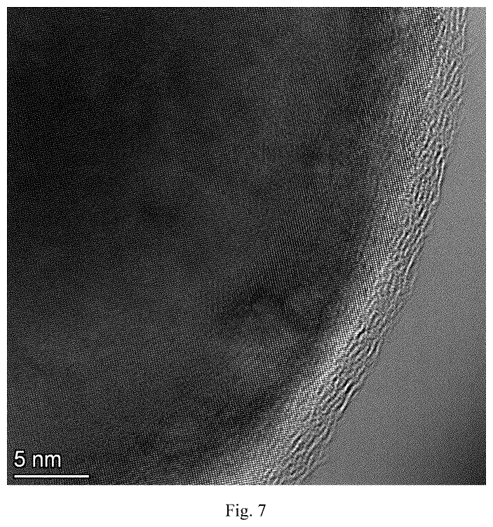

FIG. 7 shows an image of microscopic structure of the negative electrode material prepared in Example 2 of the present invention, characterized with high resolution transmission electron microscope.

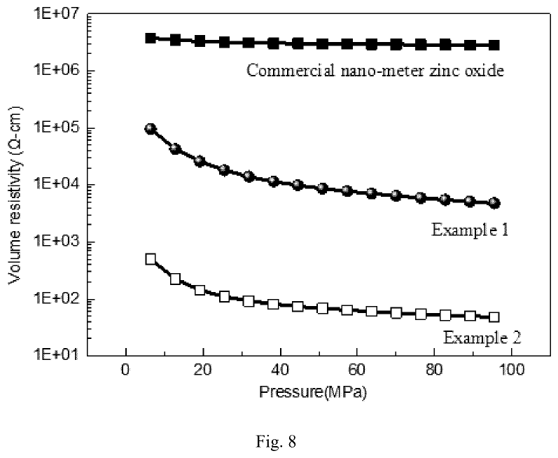

FIG. 8 shows a comparative diagram of test results of powder resistivity of the negative electrode materials.

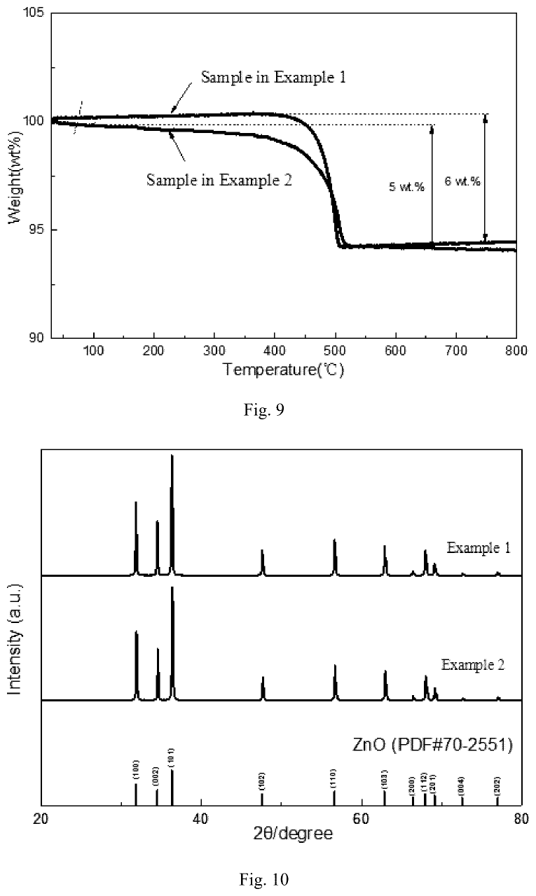

FIG. 9 shows a comparative diagram of test results with Thermal Gravimetric Analyzer (TGA) of carbon content of the negative electrode materials.

FIG. 10 shows a comparative diagram of phase analysis results of the negative electrode materials with powder X-ray diffractometer.

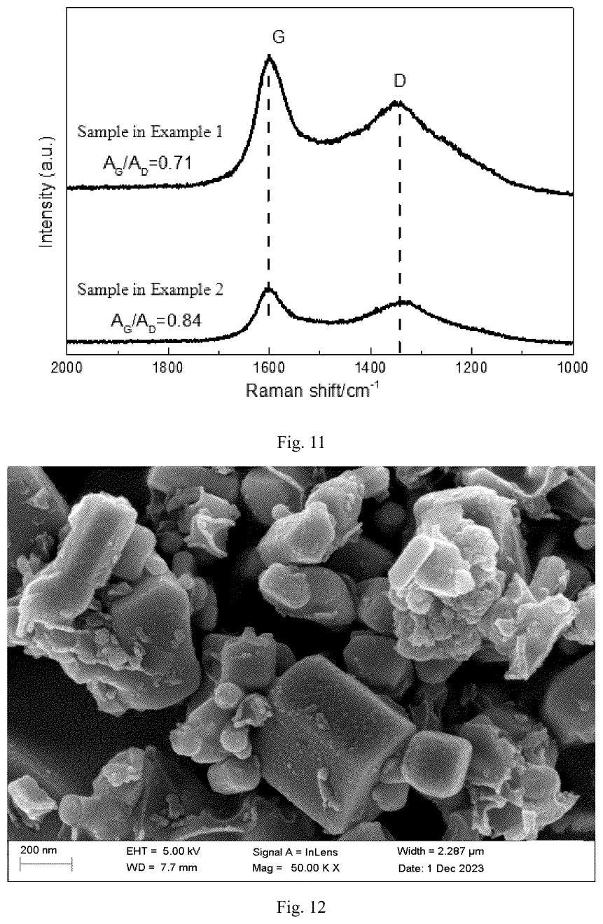

FIG. 11 shows a comparative diagram of Raman spectrum test results of the negative electrode materials.

FIG. 12 shows a field emission scanning electron microscope image of a corresponding material in Comparative Example 1.

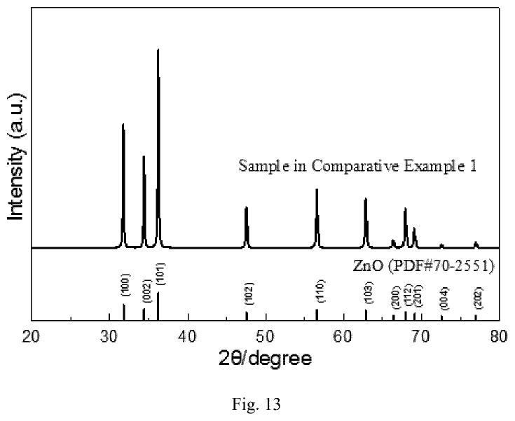

FIG. 13 shows a diagram of result of the corresponding material in Comparative Example 1 with powder X-ray diffractometer.

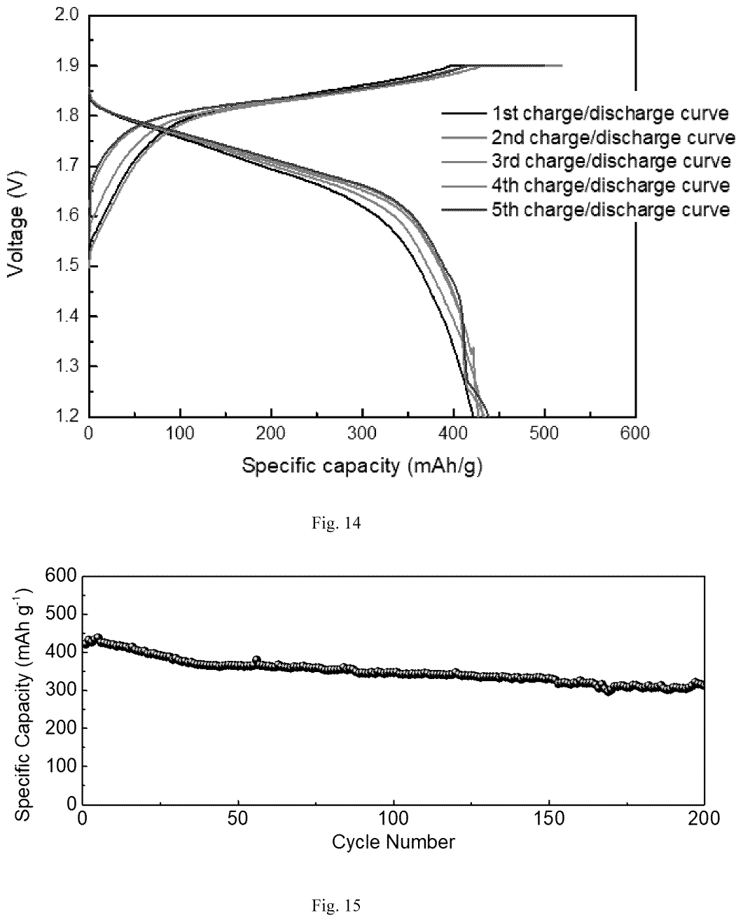

FIG. 14 shows a diagram of charge/discharge curves for the first 5 cycles of a button cell using the corresponding negative electrode material in Example 1.

FIG. 15 shows a diagram of capacity per gram for the first 200 cycles of the button cell using the corresponding negative electrode material in Example 1.

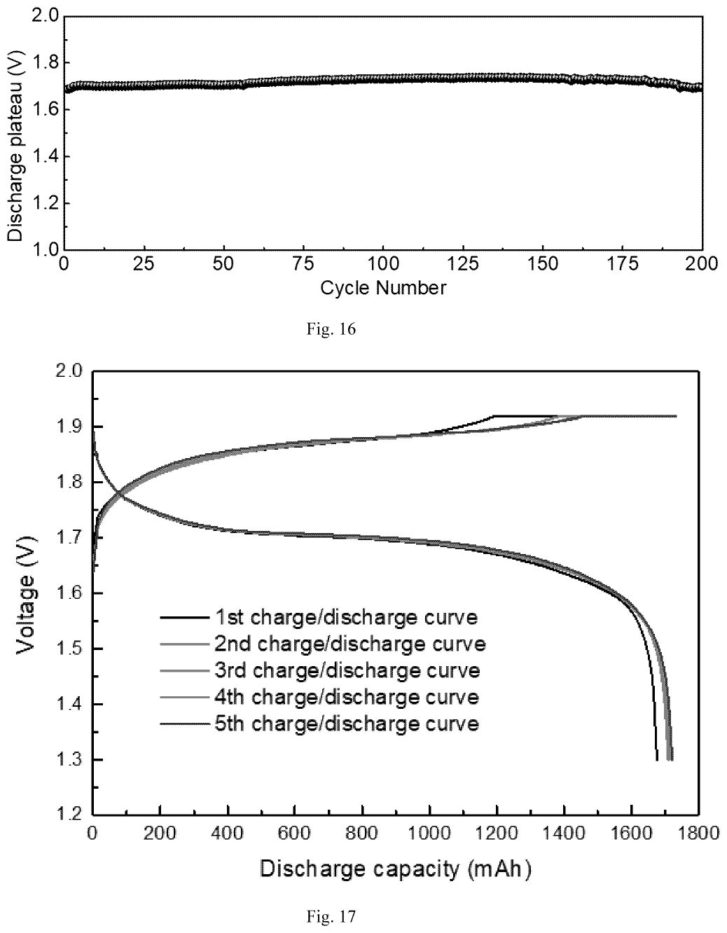

FIG. 16 shows a diagram of discharge plateau for the first 200 cycles of the button cell using the corresponding negative electrode material in Example 1.

FIG. 17 shows a diagram of charge/discharge curves for the first 5 cycles of a nickel-zinc cylindrical battery using the corresponding negative electrode material in Example 1.

### DETAILED DESCRIPTION OF EMBODIMENTS

It should be understood that specific Examples described herein are only used to explain the present invention, and are not intended to limit the present invention.

Though the present invention comprises many details, these should not be explained as a limitation on the present invention or any scope claimed for protection, but rather as a description of features that may be specific to a particular embodiment of a particular invention. Certain features described in an individual embodiment of the present invention may also be combined in one embodiment. Inversely, the various features described in a single embodiment can also be implemented in multiple embodiments individually or in any suitable subcombination. Additionally, although the features may be described above as acting in certain combinations and even initially claimed as such, one or more features from the combination claimed for protection may be removed from the combination in some cases, and the combination claimed for protection may involve a subcombination or a variant of the subcombination.

Unless otherwise indicated, the terms used herein have the same meanings as those generally understood by those skilled in the art, for example, terms with respect to raw materials and products, operating steps, process parameters, equipment and tools used, and numerical units.

### Definition

Herein, the terms “first” and “second” are used for descriptive purposes only and should not be construed as indicating or implying relative importance, or implying the number of technical features indicated. Thus, the feature that are defined with “first” and “second” may explicitly or implicitly include one feature or more features. In the description of the present invention, the term “plurality of” means the number of two or more, unless otherwise expressly and specifically indicated.

Herein, the words “including”, “comprising” and “containing” indicate open-ended or closed-ended. For example, the words “including”, “comprising” and “containing” may mean that other components or steps or other elements not listed may also be included or comprised, or that only the components or steps or other elements listed may be included or comprised.

Herein, the term “about” (e.g., in component content and reaction parameters) is interpreted in a meaning that can be generally understood by those skilled in the art. In general, the term “about” can be understood as any numerical value within plus or minus 5% of a given numerical value, e.g., about X can represent any numerical value in a range from 95% X to 105% X.

Herein, two or more elements are “substantially” the same in some respect, which is explained by the technical requirements and technical experience of those skilled in the art in specific practice. In general, the term “substantially” can be understood as that two or more elements differ by 5% or less in some respect.

It should also be understood that the specific numerical values given herein (e.g., for proportion, temperature, and duration) can be understood not only as individual numerical values, but also as providing endpoint values of a range, and can be combined with each other to provide other ranges. For example, when it is disclosed that a reaction (e.g., mixing) can be performed for 60 or 180 minutes, it is correspondingly disclosed that the reaction can be performed for 60 to 180 minutes. Additionally, the specific numerical values given herein can also be understood as being modified by the term “about” in all cases. Therefore, unless otherwise specified, the numerical value recorded in the present invention is an approximate value that can be changed according to the requirements. For example, duration of 60 minutes can be understood as the duration of about 60 minutes, and duration of 60 to 180 minutes can be understood as the duration of about 60 minutes to about 180 minutes or about 60 to 180 minutes.

Unless otherwise indicated, the terms used in the present invention have meanings normally understood by those skilled in the art.

The following methods may be adopted to perform measurement of pore diameter of microporous structure of the negative electrode material provided in the present invention.
(1) Based on the nitrogen adsorption BJH (Barrett-Joyner-Halenda) method, the pore diameter distribution is calculated, according to change rate of micropore volume relative to pore diameter.
(2) Based on the MP method, the pore diameter distribution is calculated, according to change rate of micropore volume relative to pore diameter.
(3) It is calculated based on the non-localized density functional theory method, i.e. NLDFT method).

It should be noted that in Examples of the present invention, surface morphology and microstructure of a composite negative electrode material are respectively observed by using a field emission scanning electron microscope (FE-SEM) and a high-resolution transmission electron microscope (HRTEM), and thickness of a carbon coating layer is determined. Tap density of the composite negative electrode material powder is measured by using a tap density meter, specific surface area of the composite negative electrode material is measured by the nitrogen adsorption method (multi-point BET method), and pore size distribution of the composite negative electrode material is confirmed by the NLDFT model. Carbon content of the composite negative electrode material is determined by the thermogravimetric method TGA in an oxygen or air atmosphere, powder conductivity of the composite negative electrode material is determined with a powder conductivity tester at room temperature, a content ratio of graphitic carbon to amorphous carbon in a carbon coating is determined by means of the Raman spectroscopy, and crystalline phase structure of the composite negative electrode material is determined by the powder X-ray diffractometer (XRD). With a platform for CR2032 button cell and cylindrical battery, a charge/discharge capacity sorting and cycling cabinet is used to test and evaluate charge/discharge cycle performance of the composite negative electrode material provided in the present invention in a nickel-zinc battery system and discharge plateau thereof. The foregoing can be done with any appropriate prior art.

Comparison of physicochemical properties, electrochemical performance and performance of nickel-zinc battery between the composite negative electrode material provided in the present invention and commercial ZnO nanomaterial is shown in Table 1.

It should be pointed out that the composite negative electrode material provided in the present invention can deliver discharge capacity of 1700 mAh or more, and energy density 120 Wh/kg or more in an AA cylindrical battery, which is obviously better than those of the existing nickel-zinc cylindrical battery.

TABLE 1

| | Composite negative | ZnO nano-meter |
|---|---|---|
| Performance index | electrode material | material |
| Tap density | 0.90 to 1.40 g/cm³ | 0.72 to 0.77 g/cm³ |
| Weight fraction of carbon | 2 to 8 wt. % | N.A. |
| Thickness of the carbon | 2 to 6 nm | N.A. |
| coating layer | | |
| Powder resistivity | 10² to 10⁴ Ω · cm | About 5 × 10⁶ Ω · cm |
| Pore diameter of the carbon | 1 to 4 nm | N.A. |
| coating layer | | |
| Capacity per gram | 400 mAh/g or more | 200 to 230 mAh/g |
| Capacity of AA nickel-zinc | 1700 mAh or more | 1500 mAh or less |
| cylindrical battery | | |
| Discharge plateau | 1.69 to 1.70 V | 1.6 to 1.65 V |
| Energy density of nickel- | 120 Wh/kg or more | 70 to 90 Wh/kg |
| zinc battery | | |

A preparation method for nickel-zinc battery in the present embodiment includes the following steps:
a step of preparing a laminate formed of a positive electrode, a negative electrode and a separator;
a step of fabricating a battery assembly by housing the laminate and an alkaline electrolyte solution in a battery case together; and
a step of subjecting the battery assembly to charge and discharge, usually with a charge/discharge range of 1.2 to 1.9 V.

Since the negative electrode material provided in the present invention has better capability of inhibiting side reaction, higher charge voltage of 1.92 V or a wider charge/discharge range of 1.0 to 1.92 V may also be used.

The prepared nickel-zinc battery has higher capacity per gram and higher discharge plateau, performance decline of nickel-zinc battery during repeated charge and discharge can be effectively inhibited, and therefore, the nickel-zinc battery has higher energy density, better cyclic performance, and superior rate performance.

As the positive electrode, formerly well-known positive electrodes used in nickel-zinc battery may be used. Specifically, the positive electrode typically has a positive electrode current collector and positive electrode active substance supported by the positive electrode current collector. As an example of form of the positive electrode current collector, for example, there are exemplified metals with open pores, expansion alloys, sieving mesh, foamed articles, porous metals and foam metals etc. As a material constituting the positive electrode current collector, a metal having alkaline resistance is preferable, and nickel is more preferable.

As the positive electrode active substance, at least one of spherical nickel hydroxide, nickel oxyhydroxide and cobalt-coated nickel hydroxide may be used. In the positive electrode, the positive electrode active substance is subjected to the following electrochemical reactions.

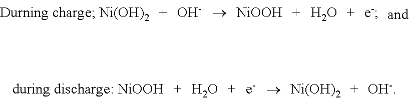

From the viewpoint of heightening performance of nickel-zinc battery, the positive electrode active substance may be solidly dissolved with zinc, cobalt, cadmium, tungsten, yttrium, zirconium, silver, titanium, magnesium, manganese, aluminium or the like elements. From the viewpoint of heightening battery characteristics, the surface of the positive electrode active substance may be coated with metal cobalt, cobalt oxide, cobaltous oxide, cobalt oxyhydroxide or the like. In addition, the positive electrode may comprise an electrically conductive material, an organic binder and the like. I.e., in the positive electrode, a positive electrode mixture containing positive electrode active substance and other components may be supported by the positive electrode current collector. As an example of the electrically conductive material, the following materials may be exemplified: metal nickel powder, cobalt powder, cobalt oxyhydroxide, cobaltous oxide or the like. As an example of the organic binder, the following binders may be exemplified: polyvinylidene difluoride (PVDF), polyvinyl alcohol (PVA), hydroxypropyl methyl cellulose (HPMC), sodium carboxymethyl cellulose (CMC), sodium polyacrylate (SPA), styrene butadiene rubber (SBR) emulsion, polyethylene oxide (PEO), hydroxyethyl cellulose (HEC) and polytetrafluoroethylene (PTFE) emulsion or the like.

The separator is a constituting member interposed between the positive electrode and the negative between electrode, enabling the positive electrode and the negative electrodes to be electrically insulated, and conducting hydroxide ions. In order to meet requirement of nickel-zinc battery, the separator usually has a certain of hydrophilicity, alkaline resistance and insulativity. As the separator, formerly well-known separators used in nickel-zinc battery may be used. As the separator, for example, resin-made porous film, resin-made non-woven fabric, plant fiber and chemical fiber composite separator or the like may be used. As an example of the resin, polyolefin (polyethylene (PE), polypropylene (PP) or the like), fluorine-based polymer, cellulose-based polymer, polyimide, nylon or the like may be exemplified. The separator may be single-layer structure, and may also be a layered structure with two or more layers (for example, three-layer structure with both sides of PE layer layered with PP layer). In addition, as the separator, such separators may be used, wherein a porous substrate is adhered with oxides such as aluminium oxide, fumed silica, boehmite, titanium dioxide, or magnesium oxide and/or nitrides such as aluminium nitride, silicon nitride, nitride titanium, or boron nitride. A composite separator of a separator for nickel-metal hydride battery with better liquid-absorbing capability and a microporous separator for lithium battery with better dendrite-proof capability is usually adopted, so as to prolong cycle life of nickel-zinc battery.

As the negative electrode, it has a negative electrode current collector and negative electrode active substance supported by the negative electrode current collector. The negative electrode active substance is the negative electrode material provided in the present invention. The negative electrode of nickel-zinc battery is mainly subjected to the following electrochemical reactions.

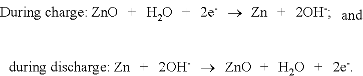

The negative electrode current collector is preferably porous negative electrode current collector, which may be exemplified as, for example, metals with open pores, expansion alloys, sieving mesh, foamed articles, porous metals, punched foil strip and porous foil material with three dimensional structure or the like. As a material constituting the porous negative electrode current collector, metals with high electrically conductivity are preferable, copper, tin, zinc, silver, copper-zinc alloy (for example, brass or the like) and copper-tin alloy are more preferable, and tinplated copper foil is most preferable. In addition, the negative electrode current collector should have at least electrically conductivity and alkaline resistance on the surface. Therefore, the negative electrode current collector may have such structure that surface thereof is made of copper, tin or copper alloy, and interior thereof is made of other materials such as zinc, nickel or stainless steel, and the material used for interior is not limited to metals. Thus, copperplated, tinplated, zinc-plated, indium-plated or carbon-sprayed non-woven fabric etc. may also be used as the negative electrode current collector. The surface of the porous negative electrode current collector may be plated with zinc, tin, bismuth, indium or the like metals or coated with carbon, preferably plated or coated with metal tin. According to such plating and coating, the surface of the negative electrode current collector can be effectively inhibited from side reaction of hydrogen evolution.

The laminate formed of the positive electrode, the negative electrode and the separator may be realized in same way as that for a laminate formed of positive electrode, negative electrode and separator in a common nickel-zinc battery, wherein the separator is interposed between the positive electrode and the negative electrode, a positive electrode current-collecting member is installed on the positive electrode of the laminate, and a negative electrode current-collecting member is installed on the negative electrode of the laminate. There are no special restrictions on the number of the positive electrode and the negative electrode used in the laminate. One positive electrode and one negative electrode may be used for fabrication of the laminate, and a plurality of positive electrodes and a plurality of negative electrodes may also be used for fabrication of the laminate. One positive electrode may be sandwiched with two negative electrodes for fabrication of the laminate.

A fabrication process of battery assembly by containing the laminate and an electrolyte solution together in a battery case may be performed in a same way as a well-known method. The battery case may be in a form of cylinder, square or other shapes disclosed in the prior art. For example, firstly, a square battery case comprising a cover is prepared. One side of the cover inside the case is arranged with a gasket, and the cover is arranged with a positive electrode terminal and a negative electrode terminal. The laminate is inserted in the battery case, the positive electrode and the positive electrode terminal are electrically connected via the positive electrode current-collecting member, and the negative electrode and the negative electrode terminal is electrically connected via the negative electrode current-collecting member. Thereafter, an alkaline electrolyte solution is uniformly injected into the battery case by a certain way (such as by means of vacuumizing or high speed centrifugation).

The alkaline electrolyte solution usually uses alkali metal hydroxide as the electrolyte. As an example of the alkali metal hydroxide, potassium hydroxide, sodium hydroxide, lithium hydroxide or the like may be exemplified, preferably potassium hydroxide. As a solvent in the electrolyte solution, deionized water is usually used, with electrical resistivity thereof of about 18 MΩ·cm. There are no special restrictions on concentration of hydroxide radical of the electrolyte, and the concentration of hydroxide radical is preferably 6 mol/L or more and 18 mol/L or less.

The nickel-zinc battery according to the present embodiment can be applied in various scenarios. For example, it may be used as power supply for driving or start-stop power supply equipped by vehicles such as electric vehicles (EV), hybrid vehicles (HV) and plug-in hybrid vehicles (PHV), as well as mobile power supply for two-wheeled vehicles, three-wheeled vehicles, engineering forklifts, and automatic guided vehicles (AGV) for warehousing etc., and may also be used as uninterruptible power supply (UPS) in household energy storage, outdoor energy storage, data centers, 5G communication base stations, and intelligent transportation systems.

### Example 1

The present Example provides a negative electrode material, and a preparation method for the negative electrode material includes the following steps:
step (1), preparing a first solution by dissolving zinc gluconate in deionized water, with concentration of zinc gluconate in the first solution of about 0.025 mol/L;
step (2), preparing a second solution by uniformly mixing 35 wt. % water-soluble polyurethane solution (CAS No.: 51852-81-4) and the first solution, with a weight ratio of the first solution to the water-soluble polyurethane being 4:1;
step (3), preparing slurry by uniformly dispersing zinc oxide particles in the second solution, with a weight ratio of the zinc oxide particles to the zinc gluconate being about 11:1;
step (4), preparing a precursor by subjecting the slurry to spray drying under air atmosphere, with inlet temperature for the spray drying controlled at 220 to 240° C., and outlet temperature for the spray drying controlled at 90 to 95° C.;
step (5), obtaining a negative electrode material by placing the precursor in a box furnace, heating it up to 600° C. at a heating rate of 10° C./min, and reacting it for 2 hours under nitrogen atmosphere, and naturally cooling the material after the reaction under protection of the atmosphere; and
step (6), obtaining a negative electrode material which may be applied in alkaline nickel-zinc battery system by subjecting the resulting negative electrode material to air jet pulverization and ultrasonic sieving, and performing particle diameter optimization by using a 300-mesh sieving mesh.

The negative electrode material provided in the present Example 1 has carbon content of about 6 wt. %, tap density of about 1.2 g/cm³, and specific surface area in accordance with nitrogen adsorption BET method of about 6 m²/g, and thickness of the carbon coating layer of about 3 nm.

FIG. 1 shows a result of surface morphology of zinc oxide particles used for preparing the negative electrode material in the present Example by means of field emission scanning electron microscope (FE-SEM) image. Zinc oxide particles have smooth surface and no obvious microporous structure, with a particle diameter range of 100 to 400 nm. FIG. 2 shows a result of microscopic structure of zinc oxide particles used for preparing the negative electrode material in the present Example by means of high resolution transmission electron microscope (HRTEM). It may be obviously seen that zinc oxide particles have not a surface coating layer, and have higher degree of crystallinity, and crystal lattice structure of zinc oxide is obvious.

FIG. 3 shows a FE-SEM image of surface morphology structure of the negative electrode material provided in the present Example 1. Obviously rough surface of zinc oxide may be seen, which is mainly related to the formed carbon coating layer on the surface of zinc oxide. FIG. 4 shows a HRTEM image of microscopic structure of the negative electrode material provided in the present Example. Zinc oxide core and a carbon coating layer on surface of the zinc oxide core may be obviously seen, with thickness of the surface of the carbon coating layer of about 4 nm. Through heat treatment at a high temperature, crystal lattice structure of zinc oxide is still clearly visible. It can be seen that the carbon coating layer has graphitic carbon with crystalline structure and amorphous carbon.

As shown in FIG. 5, in the resulting pore diameter distribution from NLDFT method, the negative electrode material provided in the present Example has two peaks within a range of 1 nm to 10 nm, with pore diameters respectively near 2 nm and 4 nm. Wherein, a ratio of total volume of micropores having pore diameter within a range of 1 nm to 4 nm to sum of volumes of all micropores of the negative electrode material is about 0.13.

### Example 2

The present Example provides a negative electrode material, and a preparation method for the negative electrode material includes the following steps:
step (1), preparing a first solution by dissolving zinc gluconate in deionized water, with concentration of zinc gluconate in the first solution of about 0.026 mol/L;
step (2), preparing a second solution by putting a mixture consisting of polyvinyl alcohol and water-soluble polyurethane (with a weight ratio of the polyvinyl alcohol to the water-soluble polyurethane being 2:3) in the first solution and uniformly mixing them, with a ratio of total weight of the polyvinyl alcohol and the water-soluble polyurethane to weight of the first solution being 1:4;
step (3), preparing slurry by uniformly dispersing zinc oxide particles in the second solution, with a weight ratio of the zinc oxide particles to the zinc gluconate being about 10:1;
step (4), preparing a precursor by subjecting the slurry to spray drying under air atmosphere, with inlet temperature for the spray drying controlled at 210 to 230° C., and outlet temperature for the spray drying controlled at 85 to 90° C.;
step (5), obtaining a negative electrode material by placing the precursor in a box furnace, heating it up to 700° C. at a heating rate of 10° C./min and reacting it for 2 hours under nitrogen atmosphere, and naturally cooling the material after the reaction under protection of the atmosphere; and
step (6), obtaining a negative electrode material which may be applied in alkaline nickel-zinc battery system by subjecting the resulting negative electrode material to air jet pulverization and ultrasonic sieving, and performing particle diameter optimization by using a 300-mesh sieving mesh.

The negative electrode material prepared in the present Example has carbon content of about 5 wt. %, tap density of about 1.1 g/cm³, and specific surface area in accordance with nitrogen adsorption BET method of about 20 m²/g. Wherein, the carbon content is slightly declined, mainly relating to increase of heat treatment temperature from 600° C. to 700° C.

FIG. 6 shows a FE-SEM image of surface morphology structure of the negative electrode material provided in the present Example 2. Obviously rough surface of zinc oxide may be seen, which is mainly related to the formed carbon coating layer on the surface of zinc oxide. FIG. 7 shows a HRTEM image of microscopic structure of the negative electrode material provided in the present Example. Zinc oxide core and a carbon coating layer on surface of the zinc oxide core may be obviously seen. Thickness of the surface of the carbon coating layer is about 2 nm. Through heat treatment at a high temperature, crystal lattice structure of zinc oxide is still clearly visible, without a problem of collapse of crystalline structure. It can be seen that the carbon coating layer has graphitic carbon with crystalline structure and amorphous carbon. It is worth mentioning that, with increase of the heat treatment temperature, the graphitic carbon structure with crystalline structure appears more obvious.

In the resulting pore diameter distribution from NLDFT method, the negative electrode material provided in the present Example has two peaks in a range of 1 nm to 10 nm, wherein a ratio of total volume of micropores having pore diameter within a range of 1 nm to 4 nm to sum of volumes of all micropores of the negative electrode material is about 0.25.

### Example 3

The present Example provides a negative electrode material, and a preparation method for the negative electrode material includes the following steps:
step (1), preparing a first solution by dissolving zinc citrate in water, with concentration of zinc citrate in the first solution being 0.1 mol/L;
step (2), preparing a second solution by uniformly mixing acrylate-based copolymer emulsion ASE95 (CAS No.: 70563-43-8) and the first solution, with a weight ratio of the first solution to the acrylate-based copolymer emulsion ASE95 of 5:1;
step (3), preparing slurry by uniformly dispersing zinc oxide particles in the second solution, with a weight ratio of zinc oxide particles to the zinc citrate being 6:1;
step (4), preparing a precursor by subjecting the slurry to spray drying;
step (5), obtaining a negative electrode material by placing the precursor in a tube furnace, heating it up to 580° C. at a heating rate of 2° C./min and reacting it for 10 hours under argon atmosphere, naturally cooling the material after the reaction under protection of argon; and
step (6), obtaining a negative electrode material which may be applied in alkaline nickel-zinc battery system by subjecting the resulting negative electrode material to air jet pulverization and ultrasonic sieving, and performing particle diameter optimization by using a 500-mesh sieving mesh.

The negative electrode material prepared in the present Example has carbon content of about 7 wt. %, tap density of about 1.0 g/cm³, and specific surface area in accordance with nitrogen adsorption BET method of about 15 m²/g, and thickness of the carbon coating layer of about 5 nm.

### Example 4

The present Example provides a negative electrode material, and a preparation method for the negative electrode material includes the following steps:
step (1), preparing a first solution by dissolving zinc lactate in deionized water, with concentration of zinc lactate in the first solution being 0.08 mol/L;
step (2), preparing a second solution by uniformly mixing acrylate-based copolymer emulsion WS32 (CAS No.: 54650-50-9) and the first solution, with a weight ratio of the first solution to the acrylate-based copolymer emulsion WS32 being 10:1;
step (3), preparing slurry by uniformly dispersing zinc oxide particles in the second solution, with a weight ratio of zinc oxide particles to the zinc lactate being 10:3;
step (4), preparing a precursor by subjecting the slurry to spray drying;
step (5), obtaining a negative electrode material by placing the precursor in a tube furnace, heating it up to 800° C. at a heating rate of 15° C./min and reacting it for 2 hours under helium atmosphere, and naturally cooling the material after the reaction under protection of helium; and
step (6), obtaining a negative electrode material which may be applied in alkaline nickel-zinc battery system by subjecting the resulting negative electrode material to air jet pulverization and ultrasonic sieving, and performing particle diameter optimization by using a 500-mesh sieving mesh.

The negative electrode material prepared in the present Example has carbon content of about 4 wt. %, tap density of about 1.1 g/cm³, and specific surface area in accordance with nitrogen adsorption BET method of about 25 m²/g, and thickness of the carbon coating layer of about 4 nm.

As shown in FIG. 8, the negative electrode materials provided in Examples 1 to 2 and zinc oxide particles are subjected to powder resistivity test. It is demonstrated from result thereof that electrically conductive performance of the negative electrode materials provided in the present invention is significantly superior to that of zinc oxide. Wherein, electrical resistivity of the negative electrode materials provided in Example 1 and Example 2 is respectively about 1×10⁴ Ω·cm and 1×10² Ω·cm, far below that of zinc oxide at nano-meter scale (5×10⁶ Ω·cm). It is worth mentioning that, with increase of the heat treatment temperature, the electrical resistivity of the negative electrode material provided in the present invention is obviously declined. Additionally, the negative electrode material provided in the present invention has lower electrical resistivity, being conducive to reducing internal resistance of battery, and promoting discharge plateau of nickel-zinc battery.

As shown in FIG. 9, the negative electrode materials provided in Examples 1 to 2 are subjected to TGA test on carbon content. It is demonstrated from result thereof that carbon content of the negative electrode materials provided in Example 1 and Example 2 is respectively about 6 wt. % and 5 wt. %. Generally, the carbon content of the negative electrode material may be appropriately reduced by appropriately heightening the temperature of heat treatment.

As shown in FIG. 10, the negative electrode materials provided in Examples 1 to 2 are subjected to powder XRD diffraction test. It is demonstrated from XRD result thereof that phases of the negative electrode materials provided in the present invention are both pure zinc oxide. Through spray drying and heat treatment at high temperature, crystalline structure of zinc oxide is not changed. At the same time, the carbon coating layer on surface of the zinc oxide core has not obvious XRD diffraction peak.

As shown in FIG. 11, the negative electrode materials provided in Examples 1 to 2 are subjected to Raman spectrum test. It is demonstrated from result thereof that the carbon coating layer on surface of the zinc oxide core is mainly consisting of graphitic carbon and amorphous carbon. Wherein, the negative electrode materials provided in Example 1 and Example 2 according to the present invention have a content ratio of graphitic carbon to amorphous carbon of 0.71:1 and 0.84:1, respectively. With increase of the heat treatment temperature, content proportion of the graphitic carbon obviously increases.

### Comparative Example 1

Difference between the present Comparative Example and Example 1 is only in that zinc gluconate is not used for preparing the negative electrode material.

FIG. 12 shows a field emission scanning electron microscope image of the corresponding material in Comparative Example 1. It is found from the study that carbon coating layer of the negative electrode material on the surface is not obvious enough that there are still particles without being completely coated. FIG. 13 shows powder X-ray diffractometer (XRD) test result of the corresponding material in Comparative Example 1. It is demonstrated from phase analysis that the negative electrode material is still dominated by the structure of zinc oxide, and no XRD diffraction peak of the carbon coating layer is observed. The corresponding material in Comparative Example 1 is subjected to TGA test on carbon content, and it is found that carbon content thereof is less than 2 wt. %. Since the carbon content is lower, the carbon coating layer on the surface of zinc oxide has poor effect, and random diffusion of zincate radical from zinc oxide negative electrode to the alkaline electrolyte solution can't be effectively inhibited. Therefore, the requirement for promoting the performance of nickel-zinc battery can't be met.

### Fabrication of Battery Assembly

The negative electrode material provided in Example 1 is used for preparing nickel-zinc button cell (CR2032) and AA cylindrical battery assembly.

A positive electrode adopts foamy nickel filled with positive electrode slurry, comprising nickel hydroxide, metal nickel, sodium carboxymethyl cellulose (CMC), and polytetrafluoroethylene (PTFE). Wherein, a weight ratio of nickel hydroxide, to metal nickel, to sodium carboxymethyl cellulose (CMC), and to polytetrafluoroethylene (PTFE) is about 94:3:2:1. In addition, coating amount of the positive electrode slurry is about 200 to 300 mg/cm², the positive electrode used for nickel-zinc button cell has a diameter of 15 mm, and the positive electrode used for AA cylindrical battery has a size of about 44 mm×92 mm.

A separator adopts a composite separator with total thickness of about 100 to 120 μm, formed by combining polypropylene non-woven fabric with strong liquid-absorbing capability and dendrite-proof polyethylene/polypropylene microporous film. In addition, the separator used for nickel-zinc button cell has a diameter of 16 mm, and the separator used for AA cylindrical battery has a size of about 47 mm×217 mm.

With regard to the negative electrode, surface of a punched and tinplated copper foil (with surface of the copper foil applied with a tinplated layer having thickness of about 2 to 4 μm) is coated with negative electrode slurry, comprising a negative electrode material, metal zinc powder, bismuth oxide, indium oxide, sodium carboxymethyl cellulose (CMC) and styrene butadiene rubber (SBR). Wherein, the negative electrode material, the metal zinc powder, the bismuth oxide, the indium oxide, and the sodium carboxymethyl cellulose (CMC) and the styrene butadiene rubber (SBR) have a weight ratio of about 85:10:2:1:2. In addition, coating amount of the negative electrode slurry used for button cell is about 2 to 10 mg/cm², and coating amount of the negative electrode slurry used for AA cylindrical battery is about 100 to 200 mg/cm². The negative electrode used for nickel-zinc button cell has a diameter of 15 mm, and the negative electrode used for AA cylindrical battery has a size of about 43 mm×120 mm.

A positive electrode sheet, a separator and a negative electrode sheet are laminated in a way of interposing the separator between the positive electrode sheet and the negative electrode sheet, to assemble a button cell and an AA cylindrical battery. A resulting laminate is directly contained in a battery case or put in the battery case by means of winding. A nickel-zinc battery assembly is prepared by injecting an electrolyte solution containing alkaline electrolyte such as potassium hydroxide, sodium hydroxide and lithium hydroxide into the battery case.

### Evaluation of Performance of Nickel-Zinc Battery

According to the fabrication process of the battery assembly, the negative electrode material provided in Example 1 is adopted, and battery performance of a nickel-zinc button cell (CR2032) using the negative electrode material is evaluated. FIG. 14 shows a diagram of charge/discharge curves of the first 5 cycles of the nickel-zinc button cell using the negative electrode material. After activation and capacity sorting steps, charge/discharge cycle is performed at a rate of 0.2 C from 1.2 V to 1.9 V regarding the negative electrode material. Capacity per gram of the negative electrode material provided in Example 1 may reach 422 mAh/g, and corresponding utilization rate of zinc oxide is about 64% during the first charge/discharge cycle. The charge/discharge capacity and voltage of the first 5 cycles remains basically stable, indicating that the negative electrode material has better electrochemical reversibility, and surface passivation and side reaction of hydrogen evolution are obviously inhibited.

FIG. 15 shows a diagram of capacity per gram of the first 200 cycles of the nickel-zinc button cell using the corresponding negative electrode material in Example 1. It is demonstrated from the study result that capacity per gram of the negative electrode material may also reach 313 mAh/g after 200 cycles, and capacity retention rate after cycles is up to 74%. Wherein, the capacity retention rate (%) is calculated by using values of discharge capacity per gram of the first charge/discharge cycle and discharge capacity per gram after predetermined cycles. Capacity per gram of button cell using pure zinc oxide negative electrode material is 200 to 230 mAh/g, with cycle number usually being only 20 to 50, mainly due to zinc dendrite and side reaction of hydrogen evolution, seriously resulting in failure of nickel-zinc battery.

Therefore, the negative electrode material provided in the present invention obviously inhibits dendrite growth, deformation of the negative electrode and side reaction of hydrogen evolution during charge/discharge, which may promote utilization rate of active substance and prolong cycle life of nickel-zinc battery.

FIG. 16 shows a diagram of discharge plateau for the first 200 cycles of the nickel-zinc button cell using the corresponding negative electrode material in Example 1. It is found from the study that discharge plateau voltage for the first 200 cycles is relatively stable, basically maintained at 1.69 to 1.70 V. Higher discharge plateau should be related to lower electrical resistivity of the negative electrode material. By reducing internal resistance of nickel-zinc battery, promotion of the discharge plateau is realized. The discharge plateau is obviously higher than discharge plateau of reported in the literature and commercialized nickel-zinc batteries of 1.60 to 1.65 V.

According to the fabrication process of battery assembly, the negative electrode material provided in Example 1 is adopted, and the performance of AA nickel-zinc cylindrical battery using the negative electrode material is evaluated. After activation and capacity sorting steps, the negative electrode material is subjected to charge/discharge cyclic test at a rate of 0.2 C from 1.3 V to 1.92 V. FIG. 17 shows a diagram of charge/discharge curves of the first 5 cycles of the AA nickel-zinc cylindrical battery using the corresponding negative electrode material in Example 1. The AA nickel-zinc cylindrical battery has a discharge capacity up to 1709 mAh and charge/discharge coulombic efficiency of 99% or more, during the first charge/discharge cyclic test. The discharge capacity of the AA cylindrical battery may be 1700 mAh or more, far higher than that of commercial AA nickel-zinc cylindrical battery (1200 to 1500 mAh), further testifying that utilization rate of the negative electrode material is obviously heightened. 99% or more of charge/discharge coulombic efficiency indicates that side reactions at the negative electrode, particularly surface passivation and side reaction of hydrogen evolution at the negative electrode, are obviously inhibited. The discharge capacity of the fifth cycle is 1722 mAh, without obvious capacity decay. The discharge plateau voltage of nickel zinc cylindrical battery is relatively stable, basically maintained at 1.69 to 1.70 V, and close to the discharge plateau of nickel zinc button cell, and however, is obviously higher than discharge plateau of commercialized AA nickel zinc cylindrical battery (1.60 to 1.65 V). It should be noted that, the highest charge voltage of the prepared nickel-zinc cylindrical battery adopting the negative electrode material provided in the present invention may be 1.92 V, higher than the highest charge voltage of commercialized AA nickel-zinc cylindrical battery of 1.9 V. It is further stated that the negative electrode material has better capabilities of inhibiting side reaction of hydrogen evolution and preventing overcharge of battery.

Based on the discharge capacity, the discharge plateau and weight of nickel-zinc battery, energy density of the nickel zinc cylindrical battery adopting the negative electrode material provided in Example 1 may be calculated to be about 122 Wh/Kg, far higher than energy density of currently commercialized nickel-zinc cylindrical battery (70 to 90 Wh/Kg).

The structure of the negative electrode material provided in the present invention can significantly inhibit generation of zinc dendrite, deformation of the zinc negative electrode and occurrence of side reaction of hydrogen evolution during charge/discharge, promoting discharge voltage plateau and utilization rate of the negative electrode material. Therefore, the negative electrode material provided in the present invention may significantly improve energy density, cycle life, rate performance and charge/discharge coulombic efficiency of nickel-zinc battery.

The technical features of Examples described above may be arbitrarily combined, and for the sake of conciseness, all possible combinations of the technical features in the above Examples are not described. However, as long as there is no contradiction between the combinations of these technical features, they shall be deemed to be within the scope of this description.

The above Examples only express several embodiments of the present invention, and description thereof is more specific and detailed, but they cannot be understood as limiting the scope of protection of the invention. It should be noted that for a person skilled in the art, a number of variants and improvements can be made without departing from the conception of the present invention, which are within the scope of protection of the present invention. Therefore, the scope of protection of the invention shall be determined by the appended claims.

1. A negative electrode material having core-shell structure, comprising zinc oxide core and a carbon coating layer on surface of the zinc oxide core, characterized in that,
weight fraction of the carbon coating layer is 2 wt. % to 8 wt. %, based on total weight of the negative electrode material;
tap density of the negative electrode material is 0.90 g/cm³ to 1.40 g/cm³;
the carbon coating layer has microporous structure with pore diameter of about 1 nm to 4 nm, and a ratio of total volume of micropores with pore diameter in a range of 1 nm to 4 nm in the carbon coating layer to sum of volumes of all micropores of the negative electrode material is 0.1 to 0.5; and
thickness of the carbon coating layer is 2 nm to 6 nm.

2. The negative electrode material according to claim 1, characterized in that, a content ratio of graphitic carbon to amorphous carbon in the carbon coating layer is 0.3 to 0.9:1.

3. A method for preparing the negative electrode material according to claim 2, including the following steps:
a step of preparing a first solution by dissolving an organic zinc source in a solvent;
a step of preparing a second solution by putting a vinyl-based polymer emulsion and/or a polyurethane resin in the first solution and uniformly mixing them;
a step of preparing slurry by uniformly dispersing zinc oxide particles in the second solution;
a step of preparing a precursor by subjecting the slurry to spray drying; and
a step of preparing the negative electrode material by sequentially subjecting the precursor to heat treatment, pulverization, and sieving.

4. The method according to claim 3, characterized in that, concentration of the organic zinc source in the first solution is 0.01 to 0.2 mol/L.

5. The method according to claim 4, characterized in that, a ratio of weight of the vinyl-based polymer emulsion and/or polyurethane resin to weight of the first solution is 1:4 to 10.

6. The method according to claim 5, characterized in that, a weight ratio of the zinc oxide particles to the organic zinc source is 5 to 20:1.

7. The method according to claim 6, characterized in that, the organic zinc source includes at least one of zinc acetate, zinc propionate, zinc butyrate, zinc valerate, zinc caproate, zinc caprylate, zinc stearate, zinc bis(2-ethylcaproate), zinc bis(butyrate), zinc oxalate, zinc gluconate, zinc citrate and zinc lactate.

8. The method according to claim 7, characterized in that, the solvent is deionized water, the organic zinc source is zinc gluconate, and the second solution is prepared by putting a mixture consisting of polyvinyl alcohol, polyurethane and polyacrylic acid in the first solution and uniformly mixing them.

9. The method according to claim 7, characterized in that, steps of subjecting the precursor to heat treatment include: in a protective gas atmosphere, placing the precursor in a box furnace, heating it up to 500 to 900° C. at a heating rate of 1 to 15° C./min and reacting it for 1 to 10 hours.

10. Use of the negative electrode material according to claim 2 in an alkaline nickel-zinc battery.
